(19) United States
(12) Patent Application Publication
(10) Pub. No.: US 2026/0326818 A1
(43) Pub. Date: Oct. 22, 2026

(54) AUTOMOBILE

(71) Applicant: Nissan Motor Co., Ltd., Yokohama-shi, Kanagawa (JP)

(72) Inventor: Yasunari YONEDA, Kanagawa (JP)

(21) Appl. No.: 19/106,678

(22) PCT Filed: Sep. 26, 2022
(86) PCT No.: PCT/JP2022/035681

§ 371 Date: Feb. 26, 2025

(51) Int. Cl. B62D 6/00; A63F 13/803; B60G 17/015; B60G 17/017; B60N 2/02; B62D 5/00; B62D 5/04

(52) U.S. Cl. CPC B62D 6/008; A63F 13/803; B60G 17/0155; B60G 17/017; B60N 2/0244; B62D 5/006; B62D 5/046; B62D 5/0481

(57) ABSTRACT

An automobile includes a steering device, an entertainment execution device and a mode select controller. The steering device has a steering wheel mechanically separated from steerable wheels. An operation of the steering wheel is transmitted to the steerable wheels as an electric signal. The entertainment execution device executes entertainment software or communicates with radio control equipment. The mode select controller enables selection between an entertainment mode for operating the entertainment execution device and a driving mode for driving the automobile, and executes control according to each mode. Upon selection of the entertainment mode, the mode select controller controls the steering device so that the steerable wheels are not turned even when the steering wheel is operated.

### CROSS-REFERENCE TO RELATED APPLICATIONS

This application is a U.S. national stage application of International Application No. PCT/JP2022/035681, filed on Sep. 26, 2022.

### BACKGROUND

### Technical Field

The present invention relates to an automobile and more particularly to an automobile that allows entertainment to be enjoyed in the automobile cabin.

### Background Information

Automobiles are known that allow racing games to be enjoyed in the automobile cabin by operating various kinds of operation equipment such as a display, a steering wheel, an accelerator pedal, and a brake pedal provided in the automobile cabin (see the article of https://response.jp/article/2019/06/23/323716.html Automotive Media Response website, article published on Jun. 23, 2019, “Play games on Tesla's onboard display, latest title is ‘Beach Buggy Racing 2’ . . . . Operate with steering wheel and pedals”).

### SUMMARY

In the above conventional automobile, however, when the steering wheel is operated, the steerable wheels also turn on the spot, which may damage the tires or cause wheel alignment issues, and a problem of adversely affecting the automobiles' mechanisms may arise.

A problem to be solved by the present invention is to provide an automobile in which entertainment such as games can be enjoyed in the automobile cabin without adversely affecting the automobile's mechanisms.

The present invention solves the above problem by controlling a steering device of a steering-by-wire type so that the steerable wheels do not turn even when the steering wheel is operated upon selection of an entertainment mode in an automobile equipped with an entertainment execution device.

According to the present invention, it is possible to enjoy entertainment such as games in the automobile cabin without adversely affecting the automobile's mechanisms.

### BRIEF DESCRIPTION OF DRAWINGS

Referring now to the attached drawings which form a part of this original disclosure, illustrative embodiments are shown.

FIG. 1 is a block diagram illustrating an embodiment of an automobile according to the present invention.

FIG. 2 is a schematic diagram illustrating an example of the steering device illustrated in FIG. 1.

FIG. 3 is a front view illustrating an example of a display for allowing a driver to select between an entertainment mode and a driving mode.

FIG. 4 is a schematic diagram illustrating a situation in which a car racing game is played using the entertainment execution device of FIG. 1.

FIG. 5 is a schematic diagram illustrating a situation in which a radio control toy car is operated using the entertainment execution device of FIG. 1.

FIG. 6 is a flowchart illustrating an information processing flow executed by the automobile of FIG. 1.

FIG. 7A is a flowchart (part 1) illustrating the subroutine for the driving mode (S6) of FIG. 6.

FIG. 7B is a flowchart (part 2) illustrating the subroutine for the driving mode (S6) of FIG. 6.

FIG. 8 is a flowchart illustrating the subroutine for the entertainment mode (S7) of FIG. 6.

FIG. 9A is a flowchart (part 1) illustrating the subroutine for the game mode (S74) of FIG. 8.

FIG. 9B is a flowchart (part 2) illustrating the subroutine for the game mode (S74) of FIG. 8.

FIG. 10A is a flow chart (part 1) illustrating the subroutine for the radio control mode (S75) of FIG. 8.

FIG. 10B is a flow chart (part 2) illustrating the subroutine for the radio control mode (S75) of FIG. 8.

### DETAILED DESCRIPTION OF EMBODIMENTS

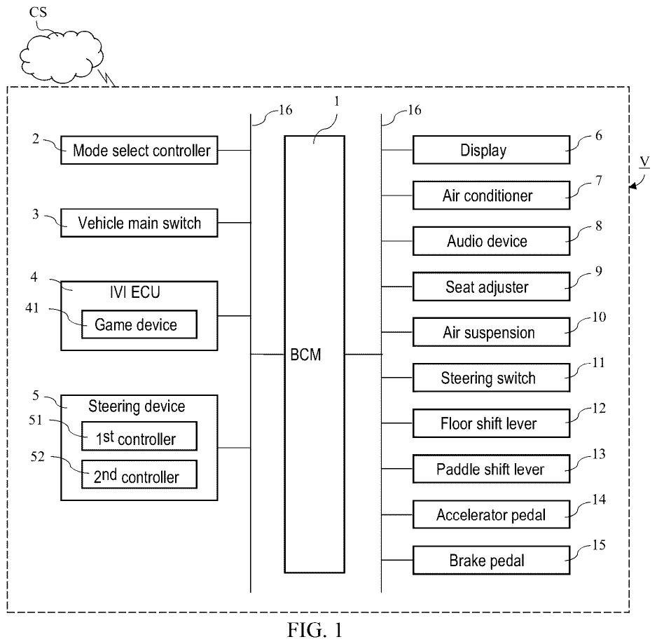

Hereinafter, an example of an embodiment for carrying out the present invention will be described with reference to the drawings. FIG. 1 is a block diagram illustrating an embodiment of the automobile according to the present invention. Automobile V of the present embodiment is equipped with an entertainment execution device 41. The entertainment execution device 41 is activated in a state in which the automobile V is stopped, and the occupants of the automobile V can enjoy racing games, maneuvering of radio control toys, etc. in the automobile cabin by operating various kinds of operation equipment such as a display 6, a steering wheel 501, an accelerator pedal 14, and a brake pedal 15 provided in the automobile cabin.

To this end, the automobile V of the present embodiment is equipped with the entertainment execution device 41 that executes racing games and other entertainment software or communicates with radio control toys and other radio control equipment, a steering device 5 of a so-called steering-by-wire type in which the steering wheel 501 is mechanically separated from steerable wheels 502 and the operation of the steering wheel 501 is transmitted to the steerable wheels 502 as an electrical signal, and a mode select controller 2 that can select between an entertainment mode for operating the entertainment execution device 41 and a driving mode for driving the automobile V.

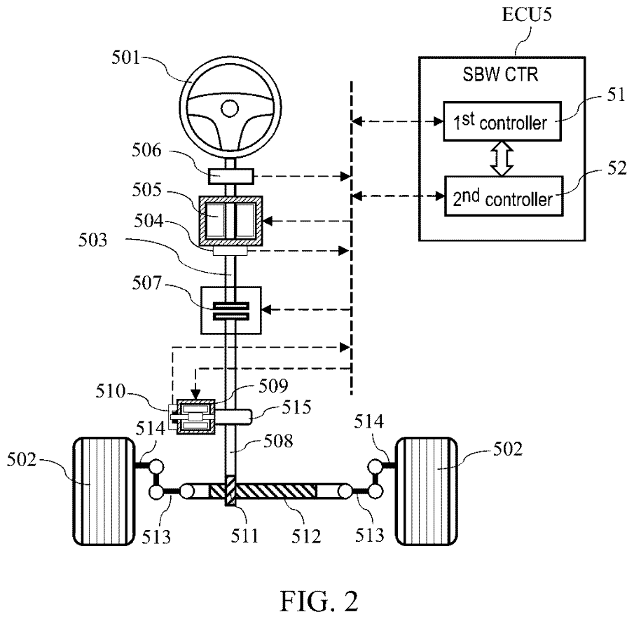

First, the steering device 5 of the steering-by-wire (SBW) type of the present embodiment will be described. FIG. 2 is a schematic diagram illustrating an example of the steering device 5 of the present embodiment. The steering device 5 includes the steering wheel 501 which can be operated by the driver, the steerable wheels 502 which are the right and left front wheels, and a steering shaft 503. The steering wheel 501 is connected to the steering shaft 503 and is provided so that it can be mechanically separated from the steerable wheels 502 and 502. This steering shaft 503 is provided with a steering angle sensor 504, a reaction force motor 505, and a steering torque sensor 506.

The steering angle sensor 504 detects the steering angle of the steering wheel 501 and can be configured of an encoder or the like.

The reaction force motor 505 applies torque to the steering shaft 503 to provide a steering reaction force to the steering wheel 501. The steering reaction force refers to a force that acts in the opposite direction to the direction in which the driver steers the steering wheel 501. The reaction force motor 505 can be configured of a brushless motor or the like, and is driven according to a reaction force motor drive current that is output from a first control unit 51 of an SBW controller ECU 5, which will be described later.

The steering torque sensor 506 detects the steering torque transmitted from the steering wheel 501 to the steering shaft 503. The steering torque sensor 506 is configured to detect the steering torque by detecting the torsional angle displacement of a torsion bar, for example, with a potentiometer.

The steering device 5 of the present embodiment further includes a clutch 507, a pinion shaft 508, a steering motor 509, a steering motor angle sensor 510, a pinion gear 511, a rack shaft 512, tie rods 513, knuckle arms 514, and an SBW controller ECU 5.

The clutch 507 is interposed between the steering wheel 501 and the steerable wheels 502 and switches between an engaged state and a disengaged state according to a clutch command current from the SBW controller ECU 5. The clutch 507 of this example is composed of an electromagnetic clutch of a non-excitation engagement type, and when the electromagnetic coil is not excited, a roller meshes between the cam surface of an input shaft and the outer ring of an output shaft, for example, by a cam roller mechanism, and the input shaft and the output shaft are engaged to come into an engaged state. On the other hand, when the electromagnetic coil is excited, the attraction of an armature disengages the roller between the cam surface of the input shaft and the outer ring of the output shaft, and the input shaft and the output shaft are disconnected to come into a disengaged state. The clutch 507 of this example is in a disengaged state when the SBW system is operating normally, and is in an engaged state when any abnormality occurs in the SBW system.

In the disengaged state of the clutch 507 of this example, the torque transmission path between the steering wheel 501 and the steerable wheels 502 is mechanically separated, so that they come to a state in which the steering operation of the steering wheel 501 is not transmitted to the steerable wheels 502. On the other hand, when the clutch 507 is in the engaged state, the torque transmission path between the steering wheel 501 and the steerable wheels 502 is mechanically connected, so that they come to a state in which the steering operation of the steering wheel 501 is transmitted to the steerable wheels 502.

One end of the pinion shaft 508 is connected to the clutch 507, and the other end is provided with the pinion gear 511. The pinion gear 511 meshes with a rack gear provided between both ends of the rack shaft 512. Both ends of the rack shaft 512 are connected to the steerable wheels 502 via the tie rods 513 and the knuckle arms 514. This allows the steerable wheels 502 to turn via the tie rods 513 and knuckle arms 514 as the rack shaft 512 is displaced in the automobile width direction in response to the rotation of the pinion gear 511. As a result, the traveling direction of the automobile V is changed.

Like the reaction force motor 505, the steering motor 509 is composed of a brushless motor or the like, and is driven in response to the steering motor drive current output by the SBW controller ECU 5. The steering motor 509 is driven according to the steering motor drive current to output a turning torque for turning the steerable wheels 502. The tip of the output shaft of the steering motor 509 is provided with a worm while the pinion shaft 508 is provided with a worm wheel, and the rotation of the steering motor 509 is transmitted to the pinion shaft 508 by meshing of the worm gear 515 composed of the worm and the worm wheel.

The steering motor 509 is provided with the steering motor angle sensor 510. The steering motor angle sensor 510 detects the rotation angle of the steering motor 509. Here, the turning angle of the steerable wheels 502 is uniquely determined by the rotation angle of the steering motor 509, the gear ratio of the worm gear 515, and the gear ratio between the pinion gear 511 and the rack gear of the rack shaft 512, so the turning angle of the steerable wheels 502 can be obtained from the rotation angle of the steering motor 509. That is, the turning angle of the steerable wheels 502 can be obtained from the angle detected by the steering motor angle sensor 510.

The SBW controller ECU 5 is composed of a microcomputer including a processor, and reads a steering angle θs of the steering wheel 501 detected by the steering angle sensor 504, a steering torque T detected by the steering torque sensor 506, and a turning angle θr detected by the steering motor angle sensor 510. In addition to this, the SBW controller ECU 5 inputs a vehicle speed Vd and a yaw rate γ from a controller (not illustrated) of another system. Then, when the clutch 507 is in the disengaged state, the SBW controller ECU 5 drives and controls the steering motor 509 according to the steering state of the steering wheel 501, and turns the steerable wheels 502. This allows the turning angle θr of the steerable wheels 502 to coincide with the steering command angle according to the steering state of the steering wheel 501. At the same time, the SBW controller ECU 5 drives and controls the reaction force motor 505 according to the turning state of the steerable wheels 502, and applies the steering reaction force to the steering wheel 501. This applies the steering reaction force, which simulates the road reaction force, to the steering wheel 501. Thus, the SBW controller ECU 5 performs steering-by-wire control (also referred to as SBW control, hereinafter).

More specifically, the SBW controller ECU 5 is configured to include a first control unit 51 and a second control unit 52. The first control unit 51 outputs a first control amount corresponding to the steering reaction force to the steering wheel to the reaction force motor 505, and the second control unit 52 outputs a second control amount corresponding to the turning angle of the steerable wheels to the steering motor 509.

Although not particularly limited, in the SBW controller ECU 5 of the present embodiment, the first control unit 51 and the second control unit 52 each read detection values required for calculation, such as the steering angle θs of the steering wheel 501 detected by the steering angle sensor 504, the steering torque T detected by the steering torque sensor 506, the turning angle θr detected by the steering motor angle sensor 510, the vehicle speed Vd, and the yaw rate γ, and independently calculate, based on these detection values, the first control amount to be output to the reaction force motor 505 and the second control amount to be output to the steering motor 509.

Then, before outputting to the reaction force motor 505 and the steering motor 509, a determination is made whether or not the first control amount and the second control amount calculated by the first control unit 51 match the first control amount and the second control amount calculated by the second control unit 52, and when they do not match, a determination is made that some abnormality occurs in the steering device 5, and a signal to that effect is output.

Although details will be described later, in the driving mode in which the automobile V is driven, the first control unit 51 outputs the first control amount corresponding to the steering reaction force applied to the steering wheel 501 to the reaction force motor 505, and the second control unit 52 outputs the second control amount corresponding to the turning angle of the steerable wheels 502 to the steering motor 509. On the other hand, in the entertainment mode in which the automobile V is stopped and the entertainment execution device 41 is operated to enjoy a game or the like, the first control unit 51 outputs the first control amount corresponding to the steering reaction force applied to the steering wheel 501 to the reaction force motor 505, while the second control unit 52 outputs 0 to the steering motor 509 as a control amount that does not change the turning angle of the steerable wheels 502. This makes it possible to stop turning the steerable wheels 502 even when the steering wheel 501 is rotated, while feeling the steering reaction force corresponding to the content of the game at the steering wheel 501.

Referring again to FIG. 1, the automobile V of the present embodiment is equipped with an IVI controller 4 including the entertainment execution device 41. The IVI controller 4 of this example means an in-vehicle infotainment device, which is composed of a microcomputer including a processor, and is a system that achieves provision of information and provision of entertainment. The IVI controller 4 of this example uses a car navigation device as having an information provision function to guide a travel route and display road traffic information. The IVI controller 4 of this example also uses an audio device 8 including a TV tuner and a display 6 as having an entertainment provision function to provide music, movies, television programs, etc. In particular, the IVI controller 4 of this example is equipped with the entertainment execution device 41, which executes racing games and other entertainment software and communicates with radio control toys and other radio control equipment. When game software is executed using the entertainment execution device 41, execution of the software content can be performed, for example, by connecting to a cloud server CS.

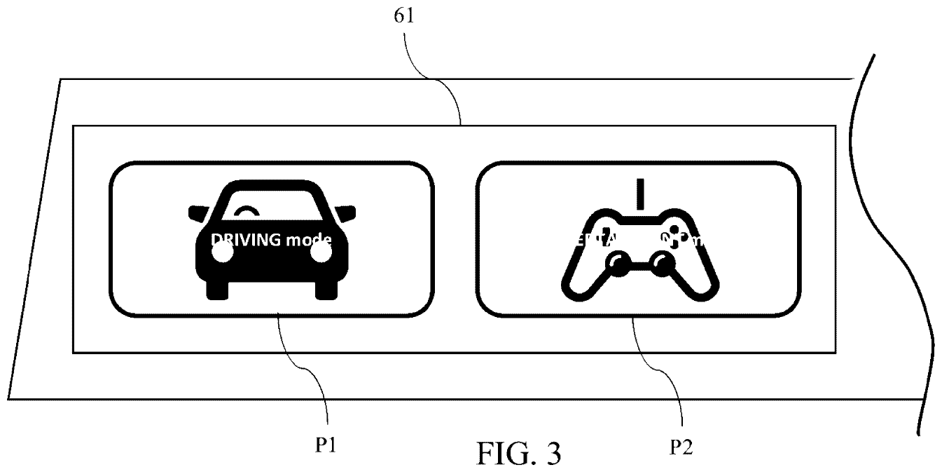

The automobile V of the present embodiment includes a mode select controller 2 that is composed of a microcomputer including a processor and that enables selection between the entertainment mode for operating the entertainment execution device 41 and the driving mode for driving the automobile V. The mode select controller 2 of this example includes a selection switch that allows the driver to select between the entertainment mode and the driving mode when a main switch 3 for starting the automobile V is turned on. FIG. 3 is a front view illustrating an example of the selection switch displayed on a center display 61 of the instrument panel for allowing the driver to select between the entertainment mode and the driving mode. When the center display 61 is composed of a liquid crystal touch panel or the like, the driver can select the desired mode by touching either a portion P1 indicating the driving mode on the left or a portion P2 indicating the entertainment mode on the right. The main switch 3 for starting the automobile V represents an ignition switch in the automobile V equipped with an internal combustion engine or represents a power switch in an electric car or a hybrid car.

Incidentally, the mode select controller 2 of this example prompts the driver to select between the entertainment mode and the driving mode each time the main switch 3 for starting the automobile V is turned on, so drivers who are not interested in the entertainment mode may feel this selection operation bothersome. For this reason, it is preferred that the mode select controller 2 of this example should be set as one of the so-called optional items when the automobile V is manufactured in response to the driver's request, and installed only in the automobile V for a purchaser who requires the entertainment mode.

The mode select controller 2 of this example not only prompts the driver to select between the entertainment mode and the driving mode when starting the automobile, but also has a function of controlling the steering device 5 so that, when the entertainment mode is selected, the steerable wheels 502 are not turned even when the steering wheel 501 is operated. This will be described later.

In addition, the mode select controller 2 of this example is configured to set the initial value of the maximum rotation angle of the steering wheel 501 when the entertainment mode is selected to the same angle as the maximum rotation angle of the steering wheel 501 when the driving mode is selected, but is configured to, in response to the driver's request, allow the maximum rotation angle of the steering wheel 501 when the entertainment mode is selected to be set to an angle smaller than the maximum rotation angle of the steering wheel 501 when the driving mode is selected. The reason why the initial value of the maximum rotation angle of the steering wheel 501 when the entertainment mode is selected is set to the same angle as the maximum rotation angle of the steering wheel 501 when the driving mode is selected is that this setting is suitable for the case in which the driving operation in the entertainment mode is used as a simulator of an actual automobile, or other similar cases.

Provided that the magnitude of the rotation angle of the steerable wheels 502 relative to the rotation angle of the steering wheel 501 is defined as an actual steering angle of the steerable wheels, the mode select controller 2 of this example is configured to, in response to the driver's request, set the actual steering angle of the steerable wheels when the entertainment mode is selected to a larger angle than the actual steering angle of the steerable wheels when the driving mode is selected. This eliminates the need to turn the steering wheel 501 widely when playing games or operating a radio control car, and allows for a quick and agile turning operation with a small operating angle. Setting of the maximum rotation angle of the steering wheel 501 can be adjusted by the control amount which is output to the reaction force motor 505 and the steering motor 509. Accordingly, the mode select controller 2 of this example may set the maximum rotation angle of the steering wheel 501 to be small (set the actual steering angle of the steerable wheels to be large) in response to the driver's request, not only when the entertainment mode is selected but also when the driving mode is selected. This eliminates the need to turn the steering wheel 501 widely during the actual driving operation, and allows for a quick and agile turning with a small operating angle.

As illustrated in FIG. 1, the automobile V of the present embodiment includes a body control module 1. The body control module 1 of this example is an electronic control unit that comprehensively controls the functions of the automobile body as a whole, and is composed of a microcomputer including a processor. Like the typical automobiles, the automobile V of the present embodiment also includes a display 6, an air conditioner 7, an audio device 8 including speakers, a radio tuner, a TV tuner, and a CD/DVD/BD player, a seat adjuster 9 that adjusts the position and posture of the seat using an actuator, an air suspension device 10 that adjusts the posture of the automobile body, a steering switch 11 provided on the steering wheel 501, a gear shift lever 12 also called a floor shift lever, a paddle shift 13 provided on the steering wheel 501, an accelerator pedal 14, and a brake pedal 15. In addition to the above, the automobile V includes lighting devices inside and outside the automobile, door locking/unlocking devices, door window glass raising/lowering devices, door mirrors, interior mirrors, windshield wipers, etc.

In the automobile V of the present embodiment, a communication path is constructed using an in-vehicle communication network (in-vehicle LAN) standard such as CSMA/CA multiplex communication (CAN: Controller Area Network) or FlexRay, and controllers including the body control module 1 are connected to each other so that they can communicate with each other via a communication line 16.

When the driving mode is selected by the mode select controller 2, a notification to that effect is output from the mode select controller 2 to the body control module 1, which controls each controller illustrated in FIG. 1 in the normal driving mode.

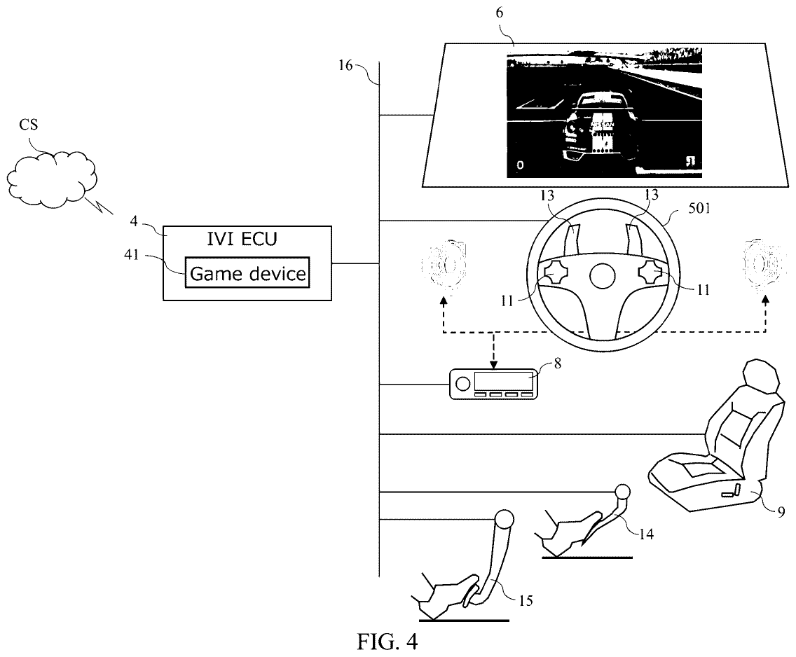

In contrast, when the entertainment mode is selected by the mode select controller 2, a notification to that effect is output from the mode select controller 2 to the body control module 1, which controls each controller according to the entertainment content executed by the entertainment execution device 41. For example, with reference to the case of playing a car racing game using the entertainment execution device 41, an example of controlling various devices of the automobile V will be described. FIG. 4 is a schematic diagram illustrating a situation in which a car racing game is played using the entertainment execution device 41.

In the car racing game as illustrated in FIG. 4, the game software is displayed on the display 6, and the driver operates the steering wheel 501, accelerator pedal 14, and brake pedal 15 while looking at the screen. In addition, when there is any operation input other than acceleration/deceleration and turning of the racing car, the operation input is made using various buttons on the steering switch 11, the paddle shift 13, the gear shift lever 12, etc. The operation amounts of operation signals input from these steering wheel 501, accelerator pedal 14, brake pedal 15, various buttons on the steering switch 11, the paddle shift 13, and the gear shift lever 12 are output to the entertainment execution device 41 via the communication line 16 and the body control module 1, and are input to the game software as the control amounts of respective operations defined by the game software. This allows the racing game to be played using the steering wheel 501 of the car V, etc.

On the other hand, when playing a car racing game, the image is displayed on the display 6 as described above, but the sound output in the racing game is output from the speakers using the audio device 8. Additionally or alternatively, in order to enhance the sense of realism in the racing game, the actuator of the seat adjuster 9 may be controlled to give vibration to the driver's seat. Likewise, the actuator of the air suspension device may be controlled to change the posture of the automobile body to give a feeling of cornering or acceleration/deceleration. Furthermore, when enjoying a role-playing game (RPG), the air conditioner 7 may be operated according to the environment in the game to change the temperature inside the automobile cabin, thereby giving a sense of realism. Thus, the sense of realism of the entertainment can be further enhanced by controlling at least one of the display 6, the air conditioner 7, the audio device 8, the seat adjuster 9, and the air suspension device 10 according to the control signal from the entertainment execution device 41. In an automobile in which an actuator that adds a reaction force against the pedaling force is provided for the accelerator pedal 14, the actuator may be controlled to add a reaction force to the accelerator pedal 14, thereby enhancing the sense of realism during acceleration, etc. Additionally or alternatively, the reaction force may be added against the pedaling force to the brake pedal by controlling the master cylinder or brake booster of the brake system, thereby giving the driver the same feeling of pedaling force as when driving an actual automobile.

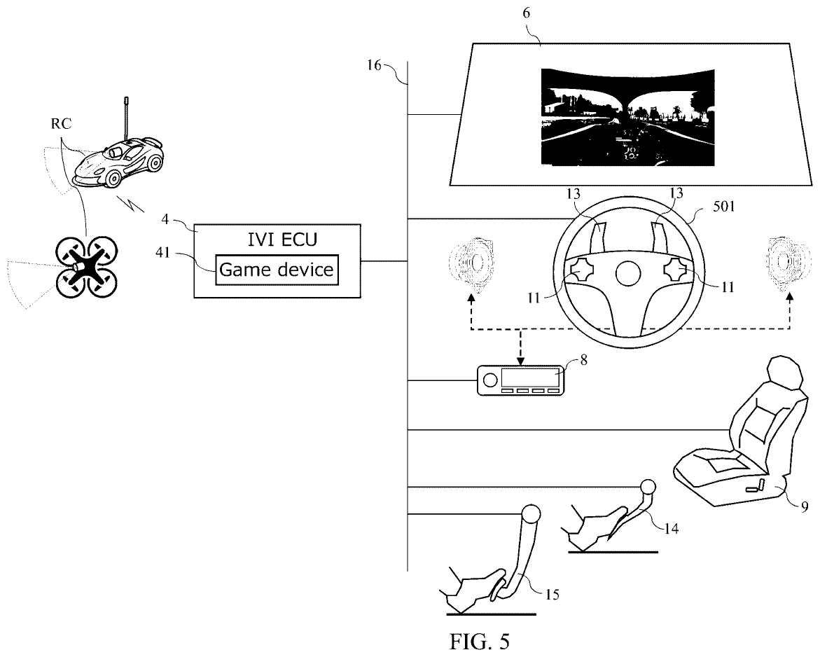

The entertainment execution device 41 of the present embodiment is used not only to execute games and other entertainment software, but also to remotely operate radio control cars or drones by communicating with radio control equipment RC. FIG. 5 is a schematic diagram illustrating a situation in which the radio control equipment RC such as a radio control car toy or a radio control drone toy is operated using the entertainment execution device 41.

In the radio control equipment RC such as a radio control car or drone as illustrated in FIG. 5, an image from a CCD camera mounted on the radio control car or drone is displayed on the display 6, and the driver operates the steering wheel 501, accelerator pedal 14, and/or brake pedal 15 while looking at this screen. In addition, when there is any operation input other than acceleration/deceleration and turning of the radio control car or drone, the operation input is made using various buttons of the steering switch 11, the paddle shift 13, the gear shift lever 12, etc. The operation amounts of operation signals input from these steering wheel 501, accelerator pedal 14, brake pedal 15, various buttons of the steering switch 11, the paddle shift 13, and the gear shift lever 12 are output to the entertainment device 41 via the communication line 16 and the body control module 1, and are input to the radio control equipment RC as the control amounts of respective operations defined in the radio control equipment RC. This allows the radio control car or a radio control drone to be operated using the steering wheel 501 of the car V, etc.

On the other hand, when operating the radio control car or radio control drone, the camera image is displayed on the display 6 as described above, but the sound output from the radio control car or radio control drone is output from the speakers using the audio device 8. Additionally or alternatively, in order to enhance the sense of realism of the radio control car or radio control drone, the actuator of the seat adjuster 9 may be controlled to give vibration to the driver's seat. Likewise, the actuator of the air suspension device may be controlled to change the posture of the automobile body to give a feeling of cornering or acceleration/deceleration. Furthermore, the air conditioner 7 may be operated according to the environment during the driving or flight to change the temperature inside the automobile cabin, thereby giving a sense of realism. Thus, the sense of realism of the entertainment can be further enhanced by controlling at least one of the display 6, the air conditioner 7, the audio device 8, the seat adjuster 9, and the air suspension device 10 according to the control signal from the entertainment execution device 41. In an automobile in which an actuator that adds a reaction force against the pedaling force is provided for the accelerator pedal 14, the actuator may be controlled to add a reaction force to the accelerator pedal 14, thereby enhancing the sense of realism during acceleration, etc. Additionally or alternatively, the reaction force may be added against the pedaling force to the brake pedal by controlling the master cylinder or brake booster of the brake system, thereby giving the driver the same feeling of pedaling force as when driving an actual automobile.

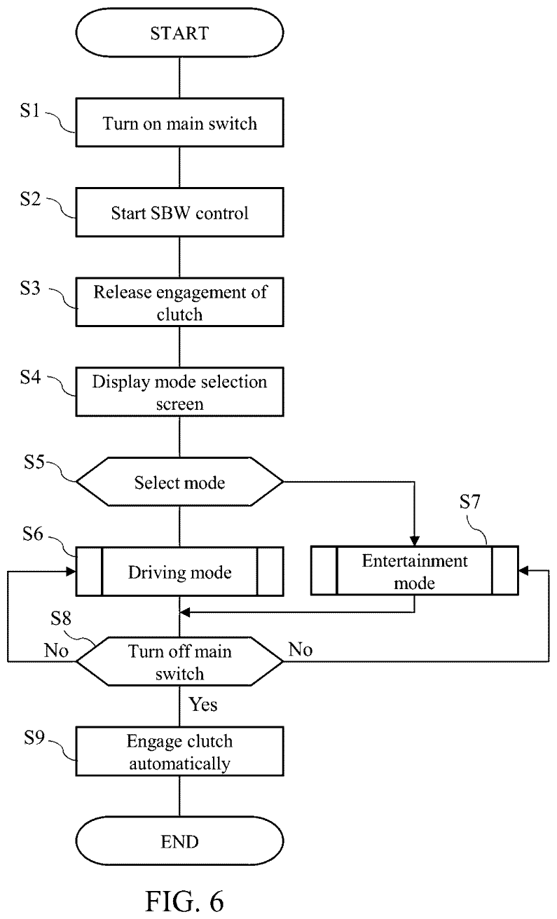

The operation of the automobile V according to the present embodiment will now be described. FIG. 6 is a flowchart illustrating the information processing flow executed by the automobile V according to the present embodiment. First, in step S1, when the driver turns on the main switch 3 of the automobile V, the internal combustion engine starts in the case of an automobile equipped with an internal combustion engine, or the power supply from the main power source to the electric system starts in the case of an electric automobile. In subsequent step S2, control by the SBW controller ECU 5 is started, and when a determination is made that there is no disadvantage in the steering device 5, the engagement of the clutch 507 is released to come to a disengaged state in step S3.

Then, in subsequent step S4, an image for selecting between the driving mode and the entertainment mode as illustrated in FIG. 3 is displayed on the center display 61, and in step S5, when the driving mode is desired, the portion P1 is touched, while when the entertainment mode is desired, the portion P2 is touched. When the portion P1 indicating the driving mode is touched, the process proceeds to step S6, whereas when the portion P2 indicating the entertainment mode is touched, the process proceeds to step S7.

In step S8, when the driving mode is selected, the driving mode continues until the driver turns off the main switch 3 of the automobile V, while when the entertainment mode is selected, the entertainment mode continues until the driver turns off the main switch 3 of the automobile V. When the driver turns off the main switch 3, the internal combustion engine stops in the case of an automobile equipped with an internal combustion engine, or the power supply from the main power source to the electric system stops in the case of an electric automobile; therefore, the clutch 507 is engaged in step S9, changing the current disengaged state to the engaged state.

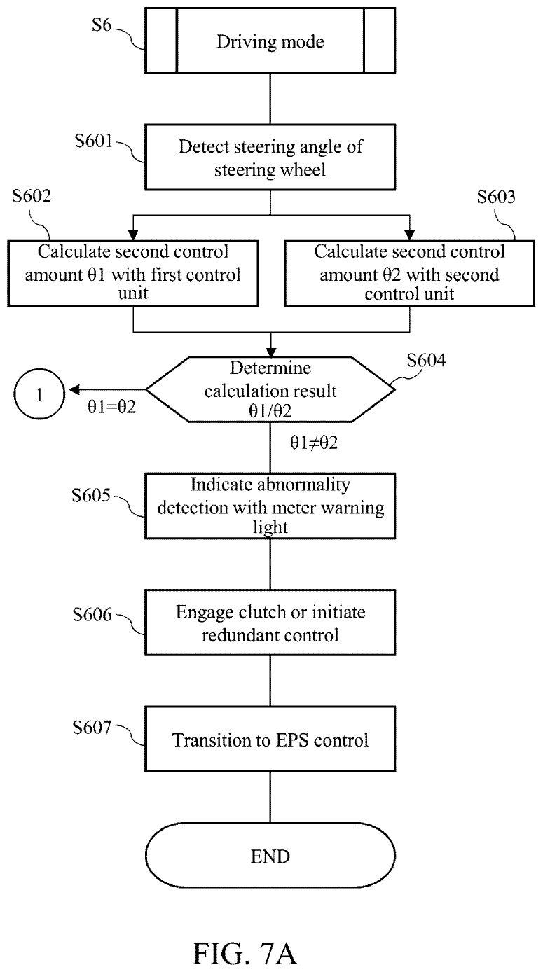

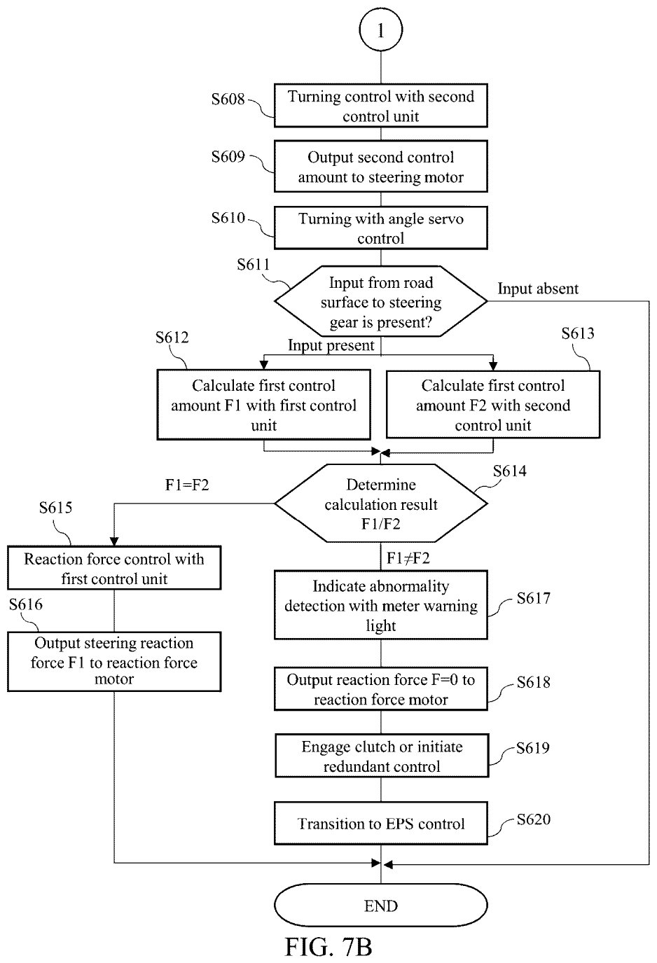

The operation of the driving mode in step S6 will then be described. FIGS. 7A and 7B are flowcharts illustrating a subroutine when the driving mode in step S6 of FIG. 6 is selected. The calculation processing illustrated in FIGS. 7A and 7B is repeated at a predetermined time interval (e.g., at intervals of several msec). When the driver selects the driving mode in step S5 of FIG. 6, the process proceeds to step S601 of FIG. 7A. In step S601, the detection signal from the steering angle sensor 504 is read out to detect the steering angle of the steering wheel 501.

When the steering angle of the steering wheel 501 is detected in step S601, in subsequent steps S602 and S603, the first control unit 51 and second control unit 52 of the SBW controller ECU 5 each read the steering angle θs of the steering wheel 501 detected by the steering angle sensor 504, as well as the steering torque T detected by the steering torque sensor 506, the vehicle speed Vd, the yaw rate γ, and other detection values required for calculation, and based on these, calculate the second control amount to be output to the steering motor 509 independently of each other. This second control amount is obtained as an output control value to the steering motor 509 corresponding to the turning angle of the steerable wheels 502. Here, it is assumed that the second control amount calculated by the first control unit 51 is θ1 and the second control amount calculated by the second control unit 52 is θ2. Although not particularly limited in the automobile according to the present invention, the first control unit 51 and the second control unit 52 execute the same calculation as in the present embodiment, and by checking the agreement of the calculation results, an abnormality in the related equipment can be found.

In step S604, the agreement between the second control amounts θ1 and θ2 calculated in steps S602 and S603, respectively, is determined. This determination of agreement may involve a certain acceptable range with consideration for calculation errors, etc. When the second control amounts θ1 and θ2 match (θ1=θ2), the process proceeds to step S608 of FIG. 7B, in which the steering control in normal cases is executed. On the other hand, when the second control amounts θ1 and θ2 do not match (θ1≠θ2), the process proceeds to step S605, in which a warning light provided on the meter display of the instrument panel is turned on to indicate that an abnormality is detected.

Subsequently, in step S606, the excitation of the electromagnetic coil of the clutch 507 is stopped, and the current disengaged state is changed to the engaged state. Alternatively, when the steering device 5 is preliminarily configured as a redundant system provided with multiple sensors, controllers, and motors, the redundant control may be initiated to activate the backup system.

Subsequently, the clutch 507 is engaged and the steering torque of the steering wheel 501 is transmitted to the pinion shaft 508, so in step S607, the process transitions to EPS control to use the steering motor 509 as an actuator of the electric power steering that assists the driver's steering operation. After that, the electric power steering control is performed with the clutch 507 engaged.

Referring again to step S604 of FIG. 7A, when the second control amounts θ1 and θ2 are the same (θ1=θ2), the process proceeds to step S608 of FIG. 7B. In steps S608 to S610 of FIG. 7B, the second control unit 52 outputs the second control amount θ2 obtained by calculation to the steering motor 509 and executes angle servo control to turn the steerable wheels 502 via the pinion shaft 508, pinion gear 511, rack shaft 512, etc. This allows the steerable wheels 502 to turn in response to the amount of operation of the steering wheel 501 by the driver, and the automobile V turns in the desired direction.

In step S611, a determination is made whether or not there is an input from the road surface to the steering gear via the steerable wheels 502. When there is no input from the road surface, there is no need to apply a reaction force to the steering wheel 501, and the subsequent processing is concluded.

On the other hand, when there is an input from the road surface, the process proceeds to steps S612 and S613, in which the first control unit 51 and second control unit 52 of the SBW controller ECU 5 each read the steering angle θs of the steering wheel 501 detected by the steering angle sensor 504, as well as the turning angle θr detected by the steering motor angle sensor 510, the steering torque T detected by the steering torque sensor 506, the vehicle speed Vd, the yaw rate γ, and other detection values required for calculation, and based on these, calculate the first control amount to be output to the reaction force motor 505 independently of each other. This first control amount is obtained as an output control value to the reaction force motor 505 corresponding to the steering reaction torque for the steering wheel 501. Here, it is assumed that the first control amount calculated by the first control unit 51 is F1 and the first control amount calculated by the second control unit 52 is F2. Although not particularly limited in the automobile according to the present invention, the first control unit 51 and the second control unit 52 execute the same calculation as in the present embodiment, and by checking the agreement of the calculation results, an abnormality in the related equipment can be found.

In step S614, the agreement between the first control amounts F1 and F2 calculated in steps S612 and S613, respectively, is determined. This determination of agreement may involve a certain acceptable range with consideration for calculation errors, etc. When the first control amounts F1 and F2 match (F1=F2), the process proceeds to step S615, in which the reaction force control by the first control unit in the normal case is executed. On the other hand, when the first control amounts F1 and F2 do not match (F1≠F2), the process proceeds to step S617, in which a warning light provided on the meter display of the instrument panel is turned on to indicate that an abnormality is detected.

Subsequently, in step S618, F=0 is output as the first control amount to the reaction force motor 505. That is, in subsequent step S619, the clutch 507 is engaged to apply the intrinsic mechanical reaction force to the steering wheel 501, or instead, redundant control is initiated, so here the first control amount output to the reaction force motor 505 is set to F=0.

Subsequently, in step S619, the excitation of the electromagnetic coil of the clutch 507 is stopped, and the current disengaged state is changed to the engaged state. Alternatively, when the steering device 5 is preliminarily configured as a redundant system provided with multiple sensors, controllers, and motors, the redundant control may be initiated to activate the backup system.

Subsequently, the clutch 507 is engaged and the steering torque of the steering wheel 501 is transmitted to the pinion shaft 508, so in step S620, the process transitions to EPS control to use the steering motor 509 as an actuator of the electric power steering that assists the driver's steering operation. After that, the electric power steering control is performed with the clutch 507 engaged.

Referring again to step S614, when the first control amounts F1 and F2 match (F1=F2), the process proceeds to step S615. In steps S615 and S616, the first control amount F1 obtained by calculation is output to the reaction force motor 505, and a pseudo force equivalent to the steering reaction force input from the road surface is applied to the steering wheel 501. This allows the driver to feel the reaction force in response to the driving operation.

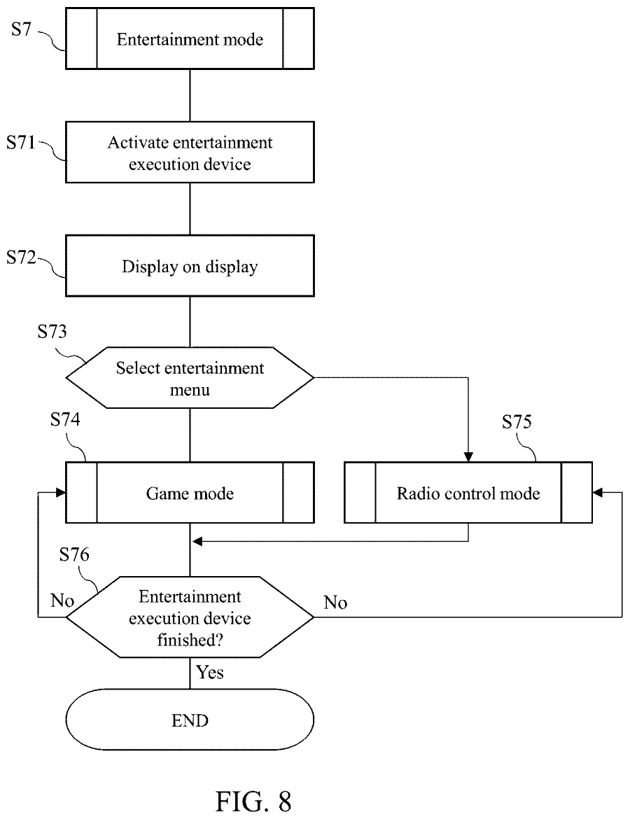

The operation of the entertainment mode in step S7 of FIG. 6 will then be described. FIG. 8 is a flowchart illustrating a subroutine when the entertainment mode in step S7 of FIG. 6 is selected. When the driver selects the entertainment mode in step S5 of FIG. 6, the process proceeds to step S71 of FIG. 8. In step S71, the entertainment execution device 41 is activated, and in subsequent step S72, an initial screen and a selection screen are displayed on the display 6. Since the entertainment execution device 41 of the present embodiment has a game mode for enjoying games and a radio control mode for enjoying radio control equipment, in subsequent step S73, the driver is prompted to select whether he/she wishes to execute the game mode or the radio control mode.

When the driver selects the game mode, the process proceeds to step S74, while when the driver selects the radio control mode, the process proceeds to step S75. Details of the game mode in step S74 and radio control mode in step S75 will be described later. In subsequent step S76, when the game mode of step S74 is selected, a determination is made whether or not the game has been finished, while when the radio control mode of step S75 is selected, a determination is made whether or not the operation of the radio control equipment has been finished, and when it has been finished, the process is concluded.

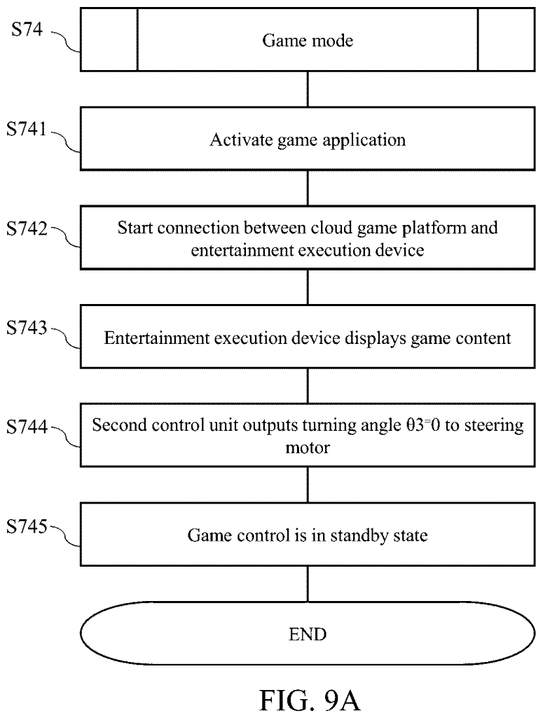

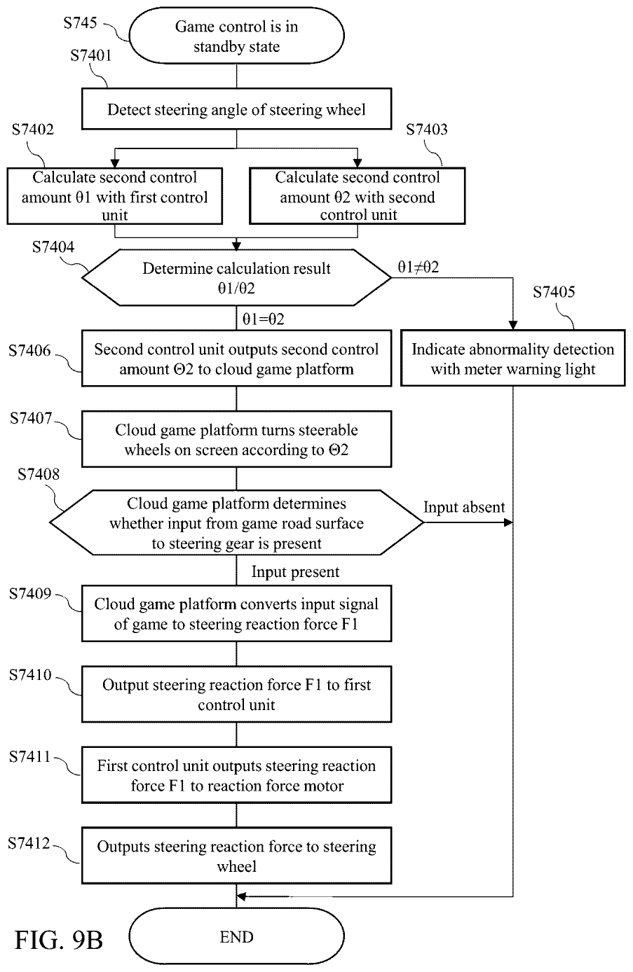

The operation when the driver selects the game mode in step S73 of FIG. 8 will then be described. FIGS. 9A and 9B are flowcharts illustrating a subroutine for the game mode in step S74 of FIG. 8. In the process flow of FIG. 9A, one routine of calculation is executed when the game mode is selected, and the process flow of FIG. 9B is executed repeatedly at a predetermined time interval (e.g., at intervals of several msec) after the game control is put into a standby state in step S745 of FIG. 9A.

First, when the driver selects the game mode, the IVI controller 4 starts the integrated control of the entertainment execution device 41 in step S741 of FIG. 9A, and the entertainment execution device 41 activates the application software for executing the game. Then, in step S742, the entertainment execution device 41 accesses a cloud server CS, connects to the cloud game platform, and activates the desired game software, here a racing car game. Through this operation, in step S743, the entertainment execution device 41 displays the content of the selected racing car game on the display 6.

In step S744, the second control unit 52 outputs θ3=0 as the turning angle to the steering motor 509. Here, when the main switch 3 of the automobile V is turned on in step S1 of FIG. 6 and then the entertainment mode is selected in step S7, the SBW control by the SBW controller ECU 5 is started in the previous step S2, and the clutch 507 is in a disengaged state in step S3. Accordingly, when the steering wheel 501 is operated to operate the racing car in the racing car game, the steerable wheels 502 are also turned by the SBW control. In the present embodiment, in order to prevent the steerable wheels 502 of the automobile V from turning when the game is executed, in step S744 before the game is started, the second control unit 52 outputs θ3=0 as the turning angle to the steering motor 509.

In step S746, the game control is in a standby state in which preparations for game control are complete, so a game start button and the like are displayed on the display 6.

When the game control is in a standby state in step S746 and the game is started, the process proceeds to step S7401 of FIG. 9B. Around the same time, images and BGM of the game content are output from the cloud game platform of the cloud server CS, so the entertainment execution device 41 to which these are input displays images of the content on the display 6 via the body control module 1, and outputs BGM from the speakers using the audio device 8. When the racing game actually starts, the driver drives the racing car in the game by operating the accelerator pedal 14 and the brake pedal 15 while operating the steering wheel 501. In step S7401, the detection signal from the steering angle sensor 504 is read out to detect the steering angle of the steering wheel 501.

When the steering angle of the steering wheel 501 is detected in step S7401, in subsequent steps S7402 and S7403, the first control unit 51 and second control unit 52 of the SBW controller ECU 5 each read the steering angle θs of the steering wheel 501 detected by the steering angle sensor 504, as well as the steering torque T detected by the steering torque sensor 506, the vehicle speed Vd, the yaw rate γ, and other detection values required for calculation, and based on these, calculate the second control amount to be output to the steering motor 509 independently of each other. Note that since the automobile V is in a state of being stopped during execution of the entertainment mode, the detection values such as the vehicle speed Vd and the yaw rate γ are those in the stopped state.

Note, however, that the second control amount in the game mode is obtained as an output control value corresponding to the turning angle of the steerable wheels of the racing car in the game content, rather than corresponding to the steerable wheels 502 of the automobile V. Here, it is assumed that the second control amount calculated by the first control unit 51 is θ1 and the second control amount calculated by the second control unit 52 is θ2. Although not particularly limited in the automobile according to the present invention, also in the game mode, the first control unit 51 and the second control unit 52 execute the same calculation as in the present embodiment, and by checking the agreement of the calculation results, the advantage is obtained that an abnormality in the related equipment can be found before driving the automobile V next time.

In step S7404, the agreement between the second control amounts θ1 and θ2 calculated in steps S7402 and S7403, respectively, is determined. This determination of agreement may involve a certain acceptable range with consideration for calculation errors, etc. When the second control amounts θ1 and θ2 match (θ1=θ2), the process proceeds to step S7406, in which the steering control in normal cases is executed. On the other hand, when the second control amounts θ1 and θ2 do not match (θ1≠θ2), the process proceeds to step S7405, in which a warning light provided on the meter display of the instrument panel is turned on to indicate that an abnormality is detected, and the game control is then finished.

Referring again to step S7404, when the second control amounts θ1 and θ2 are the same (θ1=θ2), the process proceeds to step S7406. In steps S7406 and S7407, the second control unit 52 outputs the second control amount θ2 obtained by calculation to the cloud game platform of the cloud server CS via the body control module 1 and the entertainment execution device 41, and turns the steerable wheels of the racing car. This allows the steerable wheels of the racing car to turn in response to the amount of operation of the steering wheel 501 by the driver, and the racing car in the game turns in the desired direction.

Subsequently, in step S7408, the cloud game platform of the cloud server CS determines whether or not there is an input from the road surface in the game to the steering gear via the steerable wheels of the racing car. When there is no input from the road surface, there is no need to apply a reaction force to the steering wheel 501, and the subsequent processing is terminated.

On the other hand, when there is an input from the road surface, the process proceeds to step S7409, in which the cloud game platform of the cloud server CS converts and calculates control signals related to the steering reaction force based on various detection values during the game into the first control amount F1 to be output to the reaction force motor 505 of the automobile V. This first control amount F1 is obtained as an output control value to the reaction force motor 505 corresponding to the steering reaction torque for the steering wheel 501.

In steps S7410 to S7412, the first control amount F1 output from the cloud game platform of the cloud server CS is output to the first control unit 51, and the first control unit 51, to which the first control amount F1 is input, outputs this to the reaction force motor 505. Through this operation, a pseudo force equivalent to the steering reaction force input from the road surface is applied to the steering wheel 501, and the driver can thus feel the reaction force in response to the driving operation.

Although not illustrated in FIG. 9B, in addition to reflecting the reaction force, which the racing car receives from the road surface, to the steering wheel 501 of the automobile V, the impact and acceleration/deceleration force which the racing car receives (gravity G which the driver receives) may be detected by the cloud game platform of the cloud server CS and output from the cloud game platform to the entertainment execution device 41, and the actuator of the seat adjuster 9 may be controlled to impart vibration to the driver's seat, or the actuator of the air suspension device may be controlled to change the posture of the automobile body, thereby giving a feeling of cornering or acceleration/deceleration. Additionally or alternatively, the reaction force against the pedaling force may be added to the accelerator pedal 14 or the brake pedal 15, thereby giving the driver the same feeling as when operating an actual automobile.

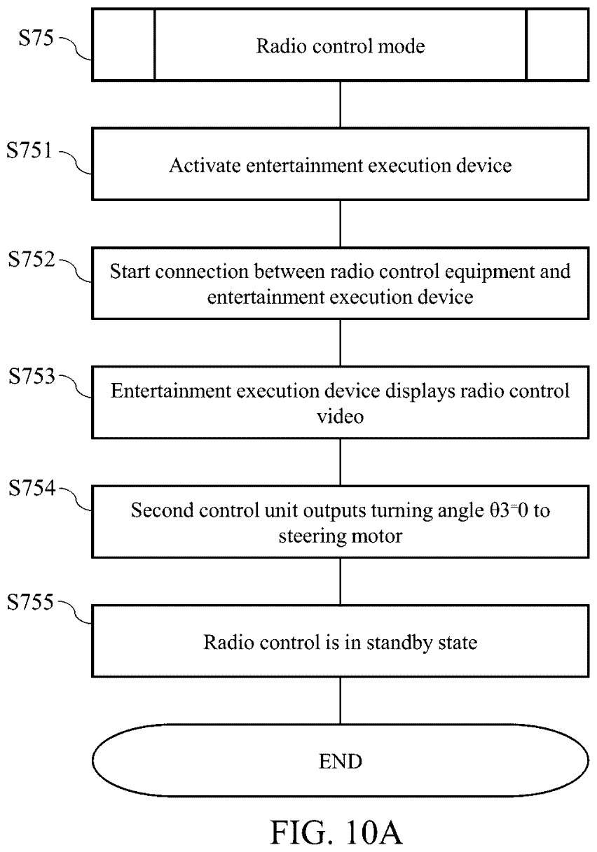

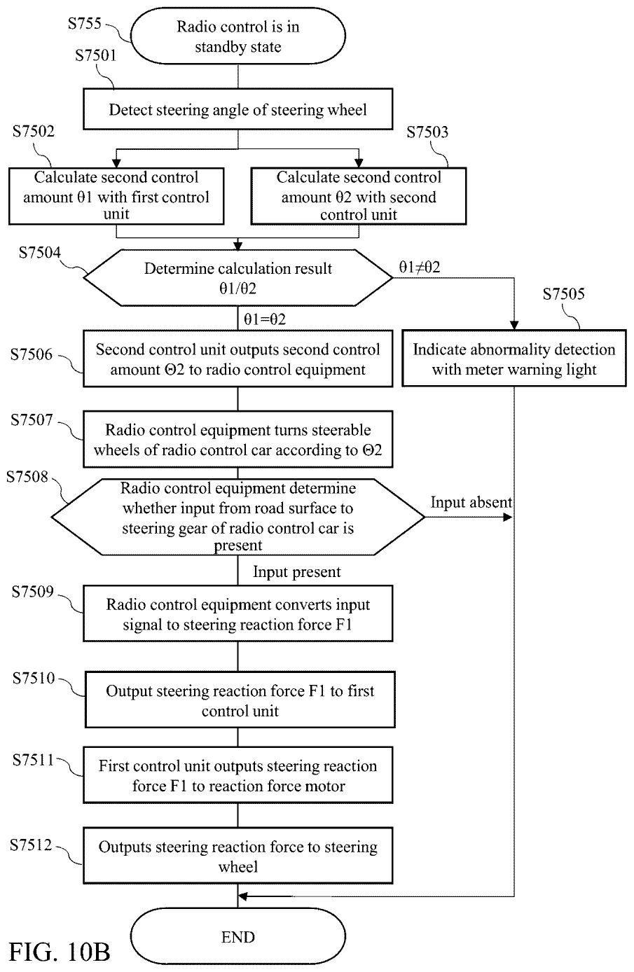

The operation when the driver selects the radio control mode in step S73 of FIG. 8 will then be described. FIGS. 10A and 10B are flowcharts illustrating a subroutine for the radio control mode in step S75 of FIG. 8. In the process flow of FIG. 10A, one routine of calculation is executed when the radio control mode is selected, and the process flow of FIG. 10B is executed repeatedly at a predetermined time interval (e.g., at intervals of several msec) after the radio control is put into a standby state in step S755 of FIG. 10A.

First, when the driver selects the radio control mode, the IVI controller 4 starts the integrated control of the entertainment execution device 41 in step S751 of FIG. 10A, and the entertainment execution device 41 activates the application software for executing the radio control operation. Then, in step S752, the entertainment execution device 41 accesses a cloud server CS, connects to the cloud game platform, and connects to the desired radio control equipment RC, here a radio control car. Through this operation, in step S753, the entertainment execution device 41 displays the captured image from a camera equipped in the selected radio control car on the display 6.

In step S754, the second control unit 52 outputs θ3=0 as the steering angle to the steering motor 509. Here, when the main switch 3 of the automobile V is turned on in step S1 of FIG. 6 and then the entertainment mode is selected in step S7, the SBW control by the SBW controller ECU 5 is started in the previous step S2, and the clutch 507 is in a disengaged state in step S3. Accordingly, when the steering wheel 501 is operated to operate the radio control car in the racing car game, the steerable wheels 502 are also turned by the SBW control. In the present embodiment, in order to prevent the steerable wheels 502 of the automobile V from turning when the radio control operation is executed, in step S754 before the game is started, the second control unit 52 outputs θ3=0 as the turning angle to the steering motor 509.

In step S756, the radio control operation is in a standby state in which preparations for control of radio control operation are complete, so a radio control operation start button and the like are displayed on the display 6.

When the control of radio control operation is in a standby state in step S756 and the radio control operation is started, the process proceeds to step S7501 of FIG. 10B. Around the same time, the radio control equipment RC outputs images captured by the camera and sounds collected by the microphone, so the entertainment execution device 41 to which these are input displays the images captured by the camera on the display 6 via the body control module 1, and outputs the collected sounds from the speakers using the audio device 8. When the remote control of the radio control car actually starts, the driver drives the radio control car, which is being remotely controlled, by operating the accelerator pedal 14 and the brake pedal 15 while operating the steering wheel 501. In step S7501, the detection signal from the steering angle sensor 504 is read out to detect the steering angle of the steering wheel 501.

When the steering angle of the steering wheel 501 is detected in step S7501, in subsequent steps S7502 and S7503, the first control unit 51 and second control unit 52 of the SBW controller ECU 5 each read the steering angle θs of the steering wheel 501 detected by the steering angle sensor 504, as well as the steering torque T detected by the steering torque sensor 506, the vehicle speed Vd, the yaw rate γ, and other detection values required for calculation, and based on these, calculate the second control amount to be output to the steering motor 509 independently of each other. Note that since the automobile V is in a state of being stopped during execution of the entertainment mode, the detection values such as the vehicle speed Vd and the yaw rate γ are those in the stopped state.

Note, however, that the second control amount in the radio control mode is obtained as an output control value corresponding to the turning angle of the steerable wheels of the operated radio control car, rather than corresponding to the steerable wheels 502 of the automobile V. Here, it is assumed that the second control amount calculated by the first control unit 51 is θ1 and the second control amount calculated by the second control unit 52 is θ2. Although not particularly limited in the automobile according to the present invention, also in the radio control mode, the first control unit 51 and the second control unit 52 execute the same calculation as in the present embodiment, and by checking the agreement of the calculation results, the advantage is obtained that an abnormality in the related equipment can be found before driving the automobile V next time.

In step S7504, the agreement between the second control amounts θ1 and θ2 calculated in steps S7502 and S7503, respectively, is determined. This determination of agreement may involve a certain acceptable range with consideration for calculation errors, etc. When the second control amounts θ1 and θ2 match (θ1=θ2), the process proceeds to step S7506, in which the steering control in normal cases is executed. On the other hand, when the second control amounts θ1 and θ2 do not match (θ1≠θ2), the process proceeds to step S7505, in which a warning light provided on the meter display of the instrument panel is turned on to indicate that an abnormality is detected, and the radio control mode is then finished.

Referring again to step S7504, when the second control amounts θ1 and θ2 are the same (θ1=θ2), the process proceeds to step S7506. In steps S7506 and S7507, the second control unit 52 outputs the second control amount θ2 obtained by calculation to the radio control equipment RC via the body control module 1 and the entertainment execution device 41, and turns the steerable wheels of the radio control car. This allows the steerable wheels of the radio control car to turn in response to the amount of operation of the steering wheel 501 by the driver, and the radio control car, which is being remotely controlled, turns in the desired direction.

Subsequently, in step S7508, the radio control equipment RC determines whether or not there is an input from the road surface to the steering gear via the steerable wheels of the radio control car. When there is no input from the road surface, there is no need to apply a reaction force to the steering wheel 501, and the subsequent processing is terminated.

On the other hand, when there is an input from the road surface, the process proceeds to step S7509, in which the radio control equipment RC converts and calculates control signals related to the steering reaction force based on various detection values during the radio control operation into the first control amount F1 to be output to the reaction force motor 505 of the automobile V. This first control amount F1 is obtained as an output control value to the reaction force motor 505 corresponding to the steering reaction torque for the steering wheel 501.

In steps S7510 to S7512, the first control amount F1 output from the radio control equipment RC is output to the first control unit 51, and the first control unit 51, to which the first control amount F1 is input, outputs this to the reaction force motor 505. Through this operation, a pseudo force equivalent to the steering reaction force input from the road surface is applied to the steering wheel 501, and the driver can thus feel the reaction force in response to the driving operation.

Although not illustrated in FIG. 10B, in addition to reflecting the reaction force, which the radio control car receives from the road surface, to the steering wheel 501 of the automobile V, the impact and acceleration/deceleration force which the radio control car receives (gravity G which the driver receives) may be detected by the radio control equipment RC and output from the radio control equipment RC to the entertainment execution device 41, and the actuator of the seat adjuster 9 may be controlled to impart vibration to the driver's seat, or the actuator of the air suspension device may be controlled to change the posture of the automobile body, thereby giving a feeling of cornering or acceleration/deceleration. Additionally or alternatively, the reaction force against the pedaling force may be added to the accelerator pedal 14 or the brake pedal 15, thereby giving the driver the same feeling as when operating an actual automobile.

As described above, the automobile V according to the present embodiment comprises: the steering device 5 in which the steering wheel 501 is mechanically separated from the steerable wheels 502 and an operation of the steering wheel 501 is transmitted to the steerable wheels 502 as an electric signal; the entertainment execution device 41 that executes entertainment software or communicates with the radio control equipment RC; and the mode select controller 2 that enables selection between the entertainment mode for operating the entertainment execution device 41 and the driving mode for driving the automobile V and executes control according to each mode. Upon selection of the entertainment mode, the mode select controller 2 controls the steering device 5 so that the steerable wheels 502 are not turned even when the steering wheel 501 is operated, and so-called stationary steering operation is therefore suppressed. As a result, damage to tires and wheel alignment issues are suppressed, and the entertainment such as games can be enjoyed inside the automobile cabin without adversely affecting the automobile's mechanisms.

Additionally or alternatively, in the automobile V of the present embodiment, the mode select controller 2 includes the selection switch that allows the driver to select between the entertainment mode and the driving mode when the main switch for starting the automobile V is turned on. That is, selection of the entertainment mode is performed only when the automobile V is started by turning on the main switch 3, and it is therefore possible to prevent the entertainment mode from being selected while driving the automobile V.

Additionally or alternatively, in the automobile V of the present embodiment, the mode select controller 2 is installed in the automobile when the automobile is manufactured in accordance with a driver's request. In other words, since the mode select controller 2 is an optional setting when the automobile is manufactured, drivers who do not need the entertainment mode can choose not to install the mode select controller 2. This can avoid the burden of having to perform the mode selection operation every time the automobile V is started.

Additionally or alternatively, in the automobile V of the present embodiment, the mode select controller 2 operates to: set an initial value of the maximum rotation angle of the steering wheel 501 when the entertainment mode is selected to an angle equal to the maximum rotation angle of the steering wheel 501 when the driving mode is selected; and in response to the driver's request, allow the maximum rotation angle of the steering wheel 501 when the entertainment mode is selected to be set to an angle smaller than the maximum rotation angle of the steering wheel 501 when the driving mode is selected. Since the initial value of the maximum rotation angle of the steering wheel 501 when the entertainment mode is selected is set to the same angle as the maximum rotation angle of the steering wheel 501 when the driving mode is selected, it is suitable for the case in which the driving operation in the entertainment mode is used as a simulator of an actual automobile, or other similar cases. Moreover, since the maximum rotation angle of the steering wheel 501 when the entertainment mode is selected can be set to a smaller angle than the maximum rotation angle of the steering wheel 501 when the driving mode is selected in response to the driver's request, it eliminates the need to turn the steering wheel 501 widely when playing games or operating a radio control car, and allows for a quick and agile turning operation with a small operating angle.

Additionally or alternatively, in the automobile V of the present embodiment, the steering device 5 includes: the reaction force motor (first actuator) 505 that applies a steering reaction force to the steering wheel 501; the steering motor (second actuator) 509 that turns the steerable wheels 502; the first control unit 51 that calculates the first control amount corresponding to the steering reaction force applied to the steering wheel 501 and controls the reaction force motor (first actuator) 505 based on the first control amount; and the second control unit 52 that calculates the second control amount corresponding to the turning angle of the steerable wheels 502 and controls the s steering motor (second actuator) 509 based on the second control amount. When the selection signal for the driving mode is input to the mode select controller 2, the first control unit 51 outputs the first control amount to the reaction force motor (first actuator) 505, and the second control unit 52 outputs the second control amount to the steering motor (second actuator) 509, while on the other hand, when the selection signal for the entertainment mode is input to the mode select controller 2, the first control unit 51 outputs the first control amount input via the entertainment execution device 41 to the reaction force motor (first actuator) 505, and the second control unit 52 outputs 0 as the second control amount to the steering motor (second actuator) 509 and outputs the second control amount to the entertainment execution device 41. This allows the so-called stationary steering operation to be suppressed in the entertainment mode, and as a result, damage to tires and wheel alignment issues are suppressed, and the entertainment such as games can be enjoyed inside the automobile cabin without adversely affecting the automobile's mechanisms. Moreover, the turning reaction force according to the traveling state in the entertainment mode can be reflected in the steering wheel 501.

Additionally or alternatively, in the automobile V of the present embodiment, the first control unit 51 and the second control unit 52 each operate to: calculate the first control amount and the second control amount based on the operation angle of the steering wheel 501; determine whether or not the first control amount F1 and the second control amount θ1 calculated by the first control unit 51 match the first control amount F2 and the second control amount θ2 calculated by the second control unit 52; and when they do not match, output a signal indicating that the steering device 5 is abnormal; therefore, abnormality detection can be performed for the steering device 5 even during selection of the entertainment mode.

Additionally or alternatively, in the automobile V of the present embodiment, the mode select controller 2 detects an operation amount of at least one of the steering wheel 501, the accelerator pedal 14, the brake pedal 15, the steering switch 11, the paddle shift 13, and the gear shift lever 12 and outputs this as a control amount to the entertainment execution device 41, and it is therefore possible to respond even to the game software and the radio control equipment RC with many input items.

Additionally or alternatively, in the automobile V of the present embodiment, the mode select controller 2 controls at least one of the display 6, the air conditioner 7, the audio device 8, the seat adjuster 9, and the air suspension device 10, and it is therefore possible to enhance the sense of realism in the game software and the radio control equipment RC.

1. An automobile comprising:
a steering device in which a steering wheel is mechanically separated from steerable wheels and an operation of the steering wheel is transmitted to the steerable wheels as an electric signal;
an entertainment execution device that executes entertainment software or communicates with radio control equipment; and
a mode select controller that enables selection between an entertainment mode for operating the entertainment execution device and a driving mode for driving the automobile and executes control according to each mode,
the mode select controller operating to:
upon selection of the entertainment mode, control the steering device so that the steerable wheels are not turned even when the steering wheel is operated;
set an initial value of a maximum rotation angle of the steering wheel when the entertainment mode is selected to an angle equal to the maximum rotation angle of the steering wheel when the driving mode is selected; and
in response to a driver's request, allow the maximum rotation angle of the steering wheel when the entertainment mode is selected to be set to an angle smaller than the maximum rotation angle of the steering wheel when the driving mode is selected.

2. The automobile according to claim 1, wherein
the mode select controller includes a selection switch that allows a driver to select between the entertainment mode and the driving mode when a main switch for starting the automobile is turned on.

3. The automobile according to claim 1, wherein
the mode select controller is installed in the automobile when the automobile is manufactured in accordance with a driver's request.

4. (canceled)

5. The automobile according to claim 1, wherein
the steering device includes:
a first actuator that applies a steering reaction force to the steering wheel;
a second actuator that turns the steerable wheels;
a first control unit that calculates a first control amount corresponding to the steering reaction force applied to the steering wheel and controls the first actuator based on the first control amount; and
a second control unit that calculates a second control amount corresponding to a turning angle of the steerable wheels and controls the second actuator based on the second control amount,
wherein when a selection signal for the driving mode is input to the mode select controller,
the first control unit outputs the first control amount to the first actuator, and
the second control unit outputs the second control amount to the second actuator,
wherein when a selection signal for the entertainment mode is input to the mode select controller,
the first control unit outputs the first control amount input via the entertainment execution device to the first actuator, and
the second control unit outputs 0 as the second control amount to the second actuator and outputs the second control amount to the entertainment execution device.

6. The automobile according to claim 5, wherein
the first control unit and the second control unit each operate to:
calculate the first control amount and the second control amount based on an operation angle of the steering wheel;
determine whether or not the first control amount and the second control amount calculated by the first control unit match the first control amount and the second control amount calculated by the second control unit; and
when they do not match, output a signal indicating that the steering device is abnormal.

7. The automobile according to claim 1, wherein
the mode select controller detects an operation amount of at least one of the steering wheel, an accelerator pedal, a brake pedal, a steering switch, a paddle shift, and a gear shift lever and outputs this as a control amount to the entertainment execution device.

8. The automobile according to claim 1, wherein
the mode select controller controls at least one of a display, an air conditioner, an audio device, a seat adjuster, and an air suspension device in response to a control signal from the entertainment execution device.
